(19) United States
(12) Patent Application Publication
(10) Pub. No.: US 2016/0217491 A1
(43) Pub. Date: Jul. 28, 2016

(54) DEVICES AND METHODS FOR PREVENTING USER CHURN

(71) Applicant: Tencent Technology (Shenzhen) Company Limited, Shenzhen (CN)

(72) Inventors: Jingtao ZHU, Shenzhen (CN); Xi HU, Shenzhen (CN); Xin XU, Shenzhen (CN); Xiaolong ZHANG, Shenzhen (CN); Hu NI, Shenzhen (CN); Duobin XU, Shenzhen (CN); Lichun LIU, Shenzhen (CN); Chengtao FAN, Shenzhen (CN); Zhibing AI, Shenzhen (CN); Xiangyong YANG, Shenzhen (CN)

(21) Appl. No.: 15/089,255

(22) Filed: Apr. 1, 2016

Related U.S. Application Data
(63) Continuation of application No. PCT/CN2014/092411, filed on Nov. 28, 2014.

(30) Foreign Application Priority Data
Nov. 29, 2013 (CN) 201310629398.0

(51) Int. Cl. G06Q 30/02; G06F 17/30; H04L 29/08

(52) U.S. Cl. CPC G06Q 30/0255; H04L 67/22; G06F 17/30598

(57) ABSTRACT

Devices and methods are provided for preventing user churn, wherein the methods include: collecting target user data corresponding to one or more target users associated with a target application program (101), the target user data including user basic attribute information, user behavioral indicator information and user active indicator information; determining a target user type of the one or more target users based on at least information associated with the target user data of the one or more target users (102), the target user type including a normal active user, an approximately silent user and a silent user; and in response to the target user type of the one or more target users being an approximately silent user, pushing first data for promoting activeness to the one or more target users associated with the target application program (103).

### CROSS-REFERENCES TO RELATED APPLICATIONS

The application claims priority to Chinese Patent Application No. 201310629398.0, filed Nov. 29, 2013, incorporated by reference herein for all purposes.

### BACKGROUND OF THE INVENTION

Certain embodiments of the present invention are directed to computer technology. More particularly, some embodiments of the invention provide devices and methods for network technology. Merely by way of example, some embodiments of the invention have been applied to application programs. But it would be recognized that the invention has a much broader range of applicability.

With the development of network technology, there are more and more types of application programs. When products on an application platform hold little attraction for users, the activeness of some users on the application platform decreases, which results in reduction of the number of users on the application platform. The number of users is one of the important indicators to measure the performance of the application platform, and can be influenced by a method of preventing user churn on the application platform. Therefore, how to prevent the user churn and increase the number of users on the application platform becomes key to build a good application platform.

To prevent the user churn, current user data is collected, and a user model is constructed based on the collected current user data. The characteristics of a churn user are determined based on the constructed user model, and then certain measures are taken to retain a user who has the same characteristics as the churn user so as to prevent the user churn.

The above-noted conventional technology has some disadvantages. For example, during the user churn prevention process, a user is retained only after the user has the characteristics of churn users, and the best time for preventing the user churn may have been missed, which negatively affects the prevention of the user churn.

Hence it is highly desirable to improve the techniques for preventing user churn.

### BRIEF SUMMARY OF THE INVENTION

According to one embodiment, a method is provided for preventing user churn. For example, target user data corresponding to one or more target users associated with a target application program is collected, the target user data including user basic attribute information, user behavioral indicator information and user active indicator information; a target user type of the one or more target users is determined based on at least information associated with the target user data of the one or more target users, the target user type including a normal active user, an approximately silent user and a silent user; and in response to the target user type of the one or more target users being an approximately silent user, first data for promoting activeness is pushed to the one or more target users associated with the target application program.

According to another embodiment, a device for preventing user churn includes: a collection module configured to collect target user data corresponding to one or more target users associated with a target application program, the target user data including user basic attribute information, user behavioral indicator information and user active indicator information; a determination module configured to determine a target user type of the one or more target users based on at least information associated with the target user data of the one or more target users, the target user type including a normal active user, an approximately silent user and a silent user; and a push module configured to, in response to the target user type of the one or more target users being an approximately silent user, push first data for promoting activeness to the one or more target users associated with the target application program.

According to yet another embodiment, a non-transitory computer readable storage medium includes programming instructions for preventing user churn. For example, target user data corresponding to one or more target users associated with a target application program is collected, the target user data including user basic attribute information, user behavioral indicator information and user active indicator information; a target user type of the one or more target users is determined based on at least information associated with the target user data of the one or more target users, the target user type including a normal active user, an approximately silent user and a silent user; and in response to the target user type of the one or more target users being an approximately silent user, first data for promoting activeness is pushed to the one or more target users associated with the target application program.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for preventing user churn according to one embodiment of the present invention.

FIG. 2 is a simplified diagram showing a method for preventing user churn according to another embodiment of the present invention.

FIG. 3 is a simplified diagram showing user types according to one embodiment of the present invention.

FIG. 4 is a simplified diagram showing a device for preventing user churn according to one embodiment of the present invention.

FIG. 5 is a simplified diagram showing a device for preventing user churn according to another embodiment of the present invention.

FIG. 6 is a simplified diagram showing a construction module as part of the device as shown in FIG. 4 and/or FIG. 5 according to one embodiment of the present invention.

FIG. 7 is a simplified diagram showing a terminal for preventing user churn according to one embodiment of the present invention.

### DETAILED DESCRIPTION OF THE INVENTION

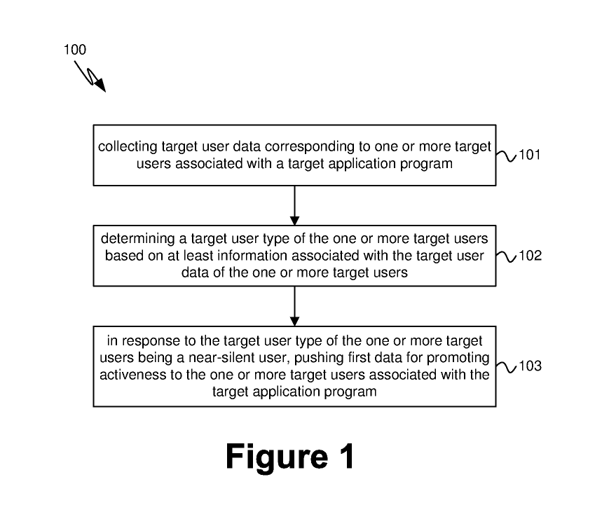

FIG. 1 is a simplified diagram showing a method for preventing user churn according to one embodiment of the present invention. The diagram is merely an example, which should not unduly limit the scope of the claims. One of ordinary skill in the art would recognize many variations, alternatives, and modifications. The method 100 includes processes 101-103.

According to one embodiment, during the process 101, user data corresponding to at least one target user in a target application program is collected, wherein the user data includes at least user basic attribute information, user behavioral indicator information and user active indicator information. For example, during the process 102, a user type of the target user is determined based on the user data of the target user, wherein the user type includes at least a normal active user, an approximately silent user and a silent user. As an example, during the process 103, if the user type of the target user is the approximately silent user, related data for promoting activeness are pushed to the target user in the target application program. As another example, prior to determining the user type of the target user based on the user data of the target user, the method 100 further comprises: pre-constructing type models corresponding to different user data.

According to another embodiment, the process 102 includes: determining the user type of the target user based on the user data of the target user and the pre-constructed type models. As an example, the pre-constructing the type models corresponding to different user data includes: selecting a preset number of users from the target application program and using as modeling users and collecting the user data of the preset number of modeling users; classifying the preset number of modeling users based on the user data of the modeling users, and determining a churn probability of each type of modeling users; determining the user type of each type of modeling users based on the churn probability of each type of modeling users, and acquiring a corresponding type model based on the user data of the modeling users corresponding to each user type. As another example, the collecting the user data of the preset number of modeling users includes: collecting the user data of the preset number of modeling users in an investigation period and a prediction period, wherein the investigation period and the prediction period are different time periods. As yet another example, the determining the churn probability of each type of modeling users comprises: determining the churn probability of each type of modeling users based on the number of the modeling users of the collected user data at the end of the investigation period and the number of the modeling users of the collected user data in the prediction period. As yet another example, the determining the user type of the target user based on the user data of the target user and the pre-constructed type models comprises: matching the user data of the target user with the user data of the modeling users corresponding to the pre-constructed type models to obtain the matched user data of the modeling users, and determining the user type corresponding to the matched user data of the modeling users as the user type of the target user.

According to some embodiments, the user data of the target user in the target application program are collected, the user type of the target user is further determined as the approximately silent user based on the user data of the target user, and then the related data for promoting activeness are pushed to the approximately silent user in time, so that retention measures are taken for the approximately silent user in time and the user churn can be effectively prevented.

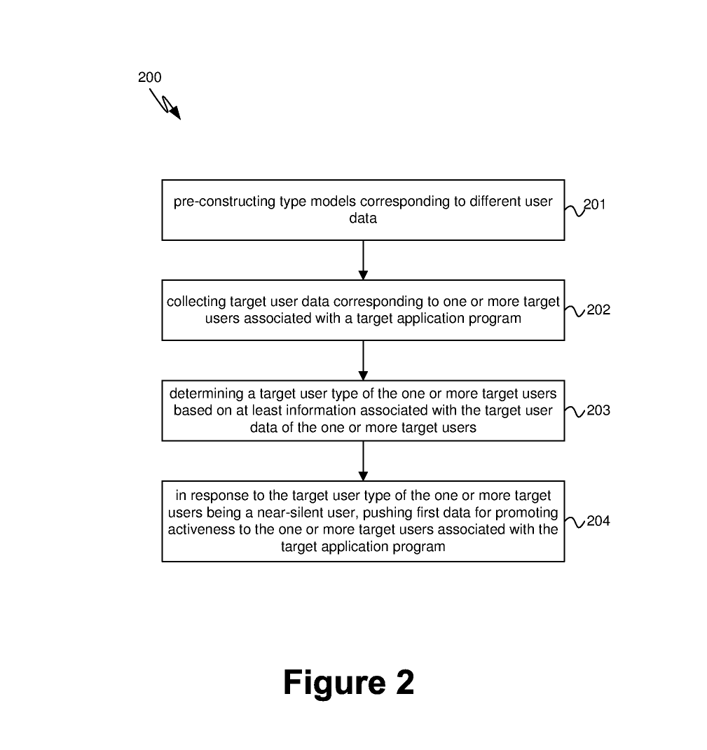

FIG. 2 is a simplified diagram showing a method for preventing user churn according to another embodiment of the present invention. The diagram is merely an example, which should not unduly limit the scope of the claims. One of ordinary skill in the art would recognize many variations, alternatives, and modifications. The method 200 includes processes 201-204.

According to one embodiment, during the process 201, type models corresponding to different user data are pre-constructed. For example, the number of users is an important indicator to measure the performance of the application platform. As an example, the churn users on the application platform have similar churn data characteristics and the retention users have similar retention data characteristics when the user data on the application platform are researched. The data characteristics are of important significance for discovering the users with churn signs in time and taking effective measures for preventing churn of the users, according to certain embodiments. For example, to prevent the user churn on the application platform and increase the number of users on the application platform, the method 200 constructs type models corresponding to different user data based on the data characteristics, and then proper measures are taken in time to prevent the user churn based on the constructed type models corresponding to different user data when the users on the application platform have the same data characteristics with the churn users in the constructed type models corresponding to different user data. As an example, the user data can include user basic attribute information, user behavioral indicator information, user active indicator information, etc. As another example, the user attribute information includes age, gender, etc. As yet another example, the user behavioral indicator information includes historical behavioral indicator information, recent behavioral indicator information, etc. As yet another example, the user active indicator information includes consecutive active days, active frequency ratio, active duration ratio, etc. A historical behavioral indicator includes installation time, installation days, historical payment amount, a payment channel, etc., according to some embodiments. For example, a recent behavioral indicator includes active days of the user in recent 7 days, 14 days and 30 days and inactive days of the user in recent 7 days, 14 days and 30 days, etc.

According to another embodiment, the process 201 includes: a preset number of users as modeling users are selected from a target application program, and user data of the preset number of modeling users are collected. For example, the target application program includes a game application program, an instant messaging application program, etc. As an example, the preset number of the users corresponds to 1 million, 2 million, 3 million, etc. As another example, the preset number of users are selected using a random selection method, etc. As yet another example, the process for collecting the user data of the preset number of modeling users includes: collecting the user data of the preset number of modeling users in an investigation period and a prediction period which are different time periods. In another example, the investigation period corresponds to three months, four months, etc. In yet another example, the prediction period corresponds to one month, two months, etc. In yet another example, the investigation period is longer than the prediction period, and different consecutive time periods are selected as the investigation period and the prediction period. For instance, a preset number of 1 million is taken as an example. In another example, when 1 million modeling users are collected, January to March can be selected as the investigation period and April can be selected as the prediction period. In yet another example, January to April can be selected as the investigation period and May can be selected as the prediction period.

According to yet another embodiment, as the collected user data of the preset number of modeling users in the investigation period and the prediction period are used for subsequently constructing the type models corresponding to different user data. For example, the method 200 further includes storing the collected user data of the preset number of modeling users in the investigation period and the prediction period after collecting the user data of the preset number of modeling users in the investigation period and the prediction period. As an example, the storing the collected user data of the preset number of modeling users in the investigation period and the prediction period includes storing the collected user data of the preset number of modeling users in the investigation period and the prediction period in a storage medium in the form of a table, a matrix, etc.

In one embodiment, the target application program includes an instant messaging application program. For example, the collected user data of the preset number of modeling users in the investigation period and the prediction period are stored in Table 1.

TABLE 1

| User instant | Application | | | Target (user |
|---|---|---|---|---|
| messaging | installation | | | churn in the |
| number | days | Age | . . . | predication period) |
| 123456 | 23 | 18 | | Yes |
| 234567 | 13 | 32 | | No |
| . . . | . . . | . . . | . . . | . . . |
| 456789 | 20 | 45 | . . . | No |

In another embodiment, the process 201 further includes: the preset number of modeling users are classified based on the user data of the modeling users, and a churn probability of each type of modeling users is determined. For example, the user data of the modeling users include user basic attribute information, user behavioral indicator information, user active indicator information, etc. As an example, after the user data of the preset number of modeling users are collected, the preset number of the modeling users can be classified based on the user data of the modeling users.

According to one embodiment, the classification of the modeling users includes: the preset number of modeling users are classified based on certain user data of the modeling users. For example, the preset number of modeling users can be classified into adult and juvenile based on age information of the user attribute information. As an example, the preset number of modeling users can be divided into users with 7 installation days, users with 14 installation days, users with 30 installation days, etc., based on the user behavioral indicator information. As another example, the preset number of modeling users are divided into users with 7 successive active days, users with 20 successive active days, users with 30 successive active days, etc., based on the successive active days in the user active indicator information. According to another embodiment, the classification of the modeling users includes: the preset number of modeling users are classified as one based on all user data of the modeling users. For instance, the preset number of modeling users can be classified based on age, gender, installation days in the user behavioral indicator information, etc. Correspondingly, different type models are determined based on each type of modeling users, according to some embodiments. For example, the type models correspond to certain user data in the modeling users. In another example, the type models correspond to all user data in the modeling users.

According to another embodiment, after the preset number of modeling users are classified based on the user data of the modeling users, the churn probability of the type of the modeling users is determined based on the type of the modeling users. For example, if the modeling users remain, the user data of the modeling users can be collected in the investigation period or in the prediction period. In another example, if the modeling user churn happens, the user data of the modeling users cannot be collected. As an example, the user data of the preset number of modeling users in the investigation period and the prediction period are collected and the preset number of modeling users are classified. The determination of the churn probability includes determining the churn probability of each type of modeling users based on the number of the modeling users of the collected user data at the end of the investigation period and the number of the modeling users of the collected user data in the predication period.

According to yet another embodiment, the determination of the churn probability of each type of modeling users based on the number of the modeling users of the collected user data at the end of the investigation period and the number of the modeling users of the collected user data in the predication period includes: collecting the number of each type of modeling users at the end of the investigation period. For example, the determination of the churn probability of each type of modeling users further includes: comparing the collected user number of each type of modeling users in the predication period with the collected user number of each type of modeling users at the end of the investigation period, and obtaining a ratio corresponding to the retention probability of each type of modeling users. In another example, the determination of the churn probability of each type of modeling users includes: acquiring the churn probability of each type of modeling users based on the retention probability of each type of modeling users. As the sum of the retention probability of each type of modeling users and the churn probability of each type of modeling users is 1, the churn probability of each type of modeling users can be acquired based on the retention probability of each type of modeling users, according to some embodiments.

According to certain embodiments, the preset number of modeling users corresponds to 1 million. For instance, the investigation period is set from January to March and the prediction period is set as April. In another example, the investigation period ends at the end of March. In yet another example, the number of juvenile users in the modeling users collected at the end of March is 180,000, the number of adult users in the modeling users collected at the end of March is 760,000, the number of juvenile users in the modeling users collected in April is 120,000 and the number of adult users in the modeling users collected in April is 600,000. As an example, the number of the juvenile users collected in the prediction period is divided by the number of the juvenile users collected at the end of the investigation period to obtain a ratio of 0.667, and the churn probability of the juvenile users is determined to be (1−0.667)*100%=0.333*100%=33.3%. As another example, the number of the adult users collected in the prediction period is divided by the number of the adult users collected at the end of the investigation period to obtain a ratio of 0.789, and the churn probability of the adult users is (1−0.789)*100%=0.211*100%=21.1%.

In yet another embodiment, the process 201 further includes: the user type of each type of modeling users is determined based on the churn probability of each type of modeling user, and the corresponding type model is acquired based on the user data of the modeling users corresponding to each user type. For example, the user type includes the normal active user, the approximately silent user and the silent user, etc. As an example, the normal active user corresponds to a user that is active during the recent 30 days and logs into the application for more than 2 days, or corresponds to a user who is active in during the recent 30 days and plays the application for more than 10 minutes. As another example, the silent user corresponds to a user who does not actively use the application within 7 days. As yet another example, the approximately silent user corresponds to a user with silence or churn characteristics. As yet another example, the churn probability of each type of modeling user can reflect the churn situation of each type of modeling user and the user type of each type of modeling user can be determined based on the churn situation of each type of modeling user. The user type of each type of modeling user can be determined based on the churn probability of each type of modeling user, according to some embodiments.

According to certain embodiments, the determination of the user type of each type of modeling user based on the churn probability of each type of modeling user includes setting a first determination threshold value and a second determination threshold value, wherein the first determination threshold value is smaller than the second determination threshold value. For example, a user with the churn probability lower than the first determination threshold value is determined as a normal active user. As an example, a user with the churn probability higher than the first determination threshold value and lower than the second determination threshold value is determined as an approximately silent user. As another example, a user with the churn probability higher than the second determination threshold value is determined as a silent user. As yet another example, the first determination threshold value can be 10%, 20%, 30%, etc. As yet another example, the second determination threshold value can be 40%, 50%, 60%, etc.

According to some embodiments, when the user type of each type of modeling user is determined based on the churn probability of each type of modeling user, the user types of the modeling users determined based on different modeling types with the same churn probability are different. For example, when the churn probability of the adult users classified based on the age in the user data of the modeling users is 40%, the user type is determined as an approximately silent user. In another example, when the churn probability of the users with 30 installation days classified based on the installation days in the user behavioral indicator information is 40%, the user type is determined as a silent user.

According to certain embodiments, when the user type of each type of modeling user is determined based on the churn probability of each type of modeling user, the user types determined based on the same modeling type with the same churn probability are different. For example, in addition to the churn probability of each type of modeling users, the user type of each type of modeling users is also determined with reference to other data such as logging-in days, active duration, active frequency, etc., so that the user types determined based on the same modeling type with the same churn probability may be different considering the other factors. As an example, when the user type of the modeling users is the adult user and the churn probability is 30%, the user type determined by the modeling users with more than 3 hours of active duration is a normal active user, and the user type determined by the modeling users with less than 2 hours of active duration is an approximately silent user. As each user type corresponds to the determined user data of the modeling users and the type models corresponding to the determined user data of the modeling users can be obtained based on the determined user data of the modeling users, the corresponding type model can be obtained based on the user data of the modeling users corresponding to each user type, according to some embodiments.

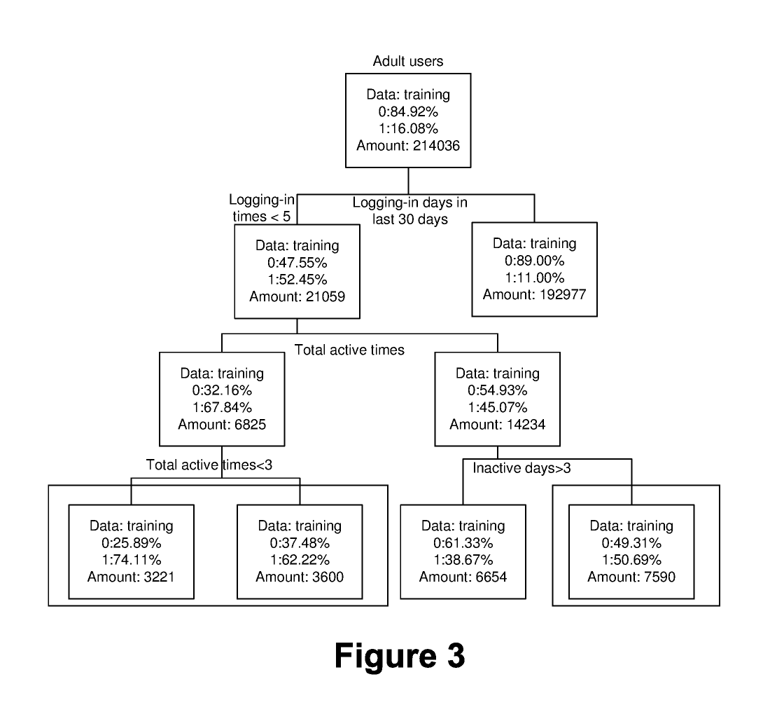

FIG. 3 is a simplified diagram showing user types according to one embodiment of the present invention. The diagram is merely an example, which should not unduly limit the scope of the claims. One of ordinary skill in the art would recognize many variations, alternatives, and modifications.

According to some embodiments, a framed user type corresponds to an approximately silent user. For example, user data of modeling users corresponding to approximately silent users includes: adult users, logging-in days, total active times and inactive days in the recent 30 days, etc. As an example, one or more type models are acquired based on user data of the modeling users corresponding to approximately silent users. As another example, the approximately silent users correspond to adult users with logging-in times less than 5, inactive days more than 3 and total active times less than 3 in the recent 30 days.

According to some embodiments, to ensure the accuracy of the pre-constructed type models corresponding to different user data, accurately determine the user type of the target user in the target application program in subsequent operations based on the pre-constructed type models corresponding to different user data, and timely take measures for approximately silent users so as to retain the approximately silent users, the pre-constructed type models corresponding to different user data are verified after the type models corresponding to different user data are pre-constructed. For example, the verification of the pre-constructed type models corresponding to different user data includes a decision tree analysis method. The decision tree analysis method involves deriving two or more events or different results when analyzing each decision or event (e.g., in a natural state), and drawing branches of the decision or event on a graph (e.g., similar to a tree). Compared with a conventional logistic regression algorithm, the decision tree analysis method acquires a more accurate result based on service explanation, according to some embodiments. For example, when the pre-constructed type models corresponding to different user data are verified with the decision tree analysis method, a user group including a certain number of users is pre-selected and is randomly divided into three parts. For instance, 40% of the users in the user group are used as a training set, 30% of the users are used as a verification set and 30% of the users are used as a test set. The training set is configured to construct the number of the modeling users of the type models corresponding to different user data, according to some embodiments. For example, 1 million of users are selected. The user number in the training set is 400,000, the user number in the verification set is 300,000 and the user number in the test set is 300,000. As an example, the 400,000 users in the training set are utilized as the modeling users to pre-construct the type models corresponding to different user data. Then, the pre-constructed type models corresponding to different user data are verified by the user data corresponding to the 300,000 users in the verification set, accurate data in the models in the training set are fitted by verification of the verification set. Finally, the fitted pre-constructed type models corresponding to different user data are tested using the test set.

Referring back to FIG. 2, the process 201 is not executed every time the method 200 is carried out, according to certain embodiments. For example, the process 201 can be executed when the method 200 is utilized for the first time. When the method 200 is utilized again, the type models that correspond to different user data and are pre-constructed during the process 201 can be directly utilized. As an example, when the pre-constructed type models corresponding to different user data are no longer applicable, the type models corresponding to different user data are constructed again, and the process 201 can be executed again.

According to some embodiments, during the process 202, user data corresponding to at least one target user in a target application program are collected. For example, the number of the target users in the target application program and the condition of the target user can be acquired from the user data corresponding to the target user in the target application program. In another example, the dynamic state of the target user in the target application program is discovered in time based on the user number and the condition of the user, so that effective measures are taken in time to retain the user when the user in the target application program has signs of churn. To prevent the churn of the target user and retain the target user with signs of churn by taking effective measures in time, the user data corresponding to the target user in the target application program is collected, according to certain embodiments. For example, the user data corresponding to at least one target user is collected for reference.

According to one embodiment, registration information of the target user in the target application program includes attribute information of the target user, and a logging-in record of the target application program includes user behavioral indicator information, user active indicator information, etc. For example, the user data includes the user attribute information, the user behavioral indicator information, the user active indicator information, etc. As an example, the collection of the user data corresponding to at least one target user in the target application program includes collecting registration information of at least one target user in the target application program and the logging-in record of the target application program. As another example, the collected registration information of the at least one target user in the target application program and the collected logging-in record of the target application program are used as the user data corresponding to at least one target user in the target application program.

According to another embodiment, as the collected user data corresponding to at least one target user in the target application program serves as an important basis for determining the approximately churn user in the target application program, the method 200 further includes storing the collected user data corresponding to at least one target user in the target application program after collecting the user data corresponding to at least one target user in the target application program. As an example, the storage of the collected user data corresponding to at least one target user in the target application program includes storing the collected user data corresponding to at least one target user in the target application program in a storage medium in the form of a table, a matrix, etc.

According to yet another embodiment, during the process 203, the user type of the target user is determined based on the user data of the target user. For example, the determination of the user type of the target user based on the user data of the target user includes: determining the user type of the target user based on the user data of the target user and the pre-constructed type model. As an example, the determination of the user type of the target user based on the user data of the target user and the pre-constructed type model includes: matching the user data of the target user with the user data of the modeling user corresponding to the pre-constructed type model so as to obtain the matched user data of the modeling user, and determining the user type corresponding to the matched user data of the modeling user as the user type of the target user. As another example, when the user data of the target user is matched with the user data of the modeling user corresponding to the pre-constructed type model, the user data of the target user is matched with the user data of the modeling user corresponding to the pre-constructed type model. As yet another example, when the user data of the target user is matched with the user data of the modeling user corresponding to the pre-constructed type model, the user data of the target user is not matched with the user data of the modeling user corresponding to the pre-constructed type model. As yet another example, the user data of the modeling user corresponding to the pre-constructed type model includes the user basic attribute information, the user behavioral indicator information, the user active indicator information, etc. As yet another example, the user basic attribute information, the user behavioral indicator information, and the user active indicator information include a plurality of user characteristics. Various judgment standards may be implemented to determine whether the user data of the target user is matched with the user data of the modeling user corresponding to the pre-constructed type model, according to some embodiments. For example, when the user characteristics in the user data of the target user and the user data of the modeling user corresponding to the pre-constructed type model are identical, it is determined that the user data of the target user is matched with the user data of the modeling user corresponding to the pre-constructed type model. In another example, when the same user characteristics in the user data of the target user and the user data of the modeling user corresponding to the pre-constructed type model exceed a preset ratio, it is determined that the user data of the target user is matched with the user data of the modeling user corresponding to the pre-constructed type model. In yet another example, the preset ratio corresponds to 50%, 70%, 90%, etc.

According to some embodiments, a juvenile user model is taken as a pre-constructed type model. For example, the user data characteristics included in the user data of the modeling users corresponding to the pre-constructed juvenile user model are as follows: male at the age of 10-15, with a ratio of the recent active times less than 0.5, few logging-in days in the recent 30 days and 3 months of application installation time. As an example, the user data of the target users is matched with the user data of the modeling users corresponding to the pre-constructed type model. If the data characteristics of the target users are the same as the user data characteristics included in the user data of the modeling users, it is determined that the user data of the target users is matched with the user data of the modeling users corresponding to the pre-constructed type model. As another example, the data characteristics of the target users are as follows: male at the age of 15-16, with a ratio of the recent active times less than 0.5, few logging-in days in the recent 30 days and 2 months of application installation time. The user data characteristics in the user data of the target users and the user data of the modeling users corresponding to the pre-constructed type model are not identical. Two user characteristics in the user data of the target users and the user data of the modeling users corresponding to the pre-constructed type model are identical, and there are four total characteristics in the user data of the target users and the user data of the modeling users corresponding to the pre-constructed type model. The ratio of the identical user characteristics to the total characteristics in the user data of the target users and the user data of the modeling users corresponding to the pre-constructed type model is 50%. For instance, a matching threshold is set as 40%. That is, if identical user characteristics in the user data of the target users and the user data of the pre-constructed type model exceeds 40%, it is determined that the user data of the target users is matched with the user data of the modeling users corresponding to the pre-constructed type model. As the ratio of the identical user characteristics to the total characteristics in the user data of the target users and the user data of the modeling users corresponding to the pre-constructed type model is 50% which exceeds the preset matching threshold, it is determined that the user data of the target users is matched with the user data of the modeling users corresponding to the pre-constructed type model.

According to certain embodiments, there are two pre-constructed type models corresponding to different user data. For example, in one pre-constructed type model, each type of user data in the modeling users corresponds to one type model, so that there are a plurality of type models. As an example, when the user data of the target users is matched with the user data of the modeling users corresponding to the pre-constructed type models, the user data of the target users is matched one-to-one with the user data of the modeling users corresponding to the plurality of pre-constructed type models. As another example, in the other pre-constructed type model, all user data of the modeling users correspond to one type model. As there is only one type model, the user data of the target users is matched with the user data of the modeling users corresponding to the pre-constructed type model when the user data of the target users is matched with the user data of the modeling users corresponding to the pre-constructed type model.

According to some embodiments, after the user data of the target user is matched with the user data of the modeling user corresponding to the pre-constructed type model, the user data of the modeling user matched with the user data of the target user can be obtained. For example, each type model includes determined user data and the determined user data included in each type model corresponds to a determined user type when the type model is constructed in advance. As an example, after the matched user data of the modeling users is obtained, the corresponding user type can be determined based on the matched user data of the modeling users, and the user type corresponding to the matched user data of the modeling users is determined as the user type of the target user.

According to one embodiment, after the user data of the target user is matched with the user data of the modeling user corresponding to the pre-constructed type model, the matched user data of the modeling user is obtained as follows: an adult, at the age of 30-40, with a low overall active frequency and one logging-in day in the recent 7 days. If the corresponding user type is determined as the approximately churn user based on the matched user data of the modeling users, the user type of the target user is also determined as the approximately churn user, according to some embodiments.

In one embodiment, during the process 204, if the user type of the target user is an approximately churn user, related data for promoting activeness are pushed to the target user in the target application program. For example, as the user type of the target user is the approximately churn user, it shows that the attraction of the target application program to the target user is decreased, and the activeness of the target user is reduced, so that the target user has a high possibility of churn. As an example, to effectively prevent churn of the target user in the target application program and increase the number of the target users in the target application program, the related data for promoting activeness is pushed to the target user in the target application program after determining the user type of the target user in the target application program as the approximately silent user. As another example, the related data for promoting activeness can be data such as props and gift bags in an advertisement and/or the target application program. As yet another example, to improve the activeness of the target user in the target application program and prevent churn of the target user whose user type is the approximately silent user in the target application program, activities are pushed to the target user for retention, in addition pushing the related data for promoting activeness to the target user in the target application program.

According to some embodiments, when the activities are pushed to the target user for retention, the target user whose user type is the approximately silent user in the target application program is firstly determined based on the pre-constructed type models corresponding to different user data. For example, the user data of the determined target user whose user type is the approximately silent user is provided to a developer. As an example, the developer develops activities capable of promoting activeness of the target user based on the user data of the target user whose user type is the approximately silent user, pushes the activities capable of promoting activeness of the target user to the application platform, and displays the activities to the target user via the application platform. As another example, the target user logs-in the application platform and sees the activities on the application platform pushed by the developer. Due to the attraction of the activities, the frequency of the target user logging-in the target application program increases, the logging-in duration increases, and the activeness of the target user in the target application program is enhanced.

According to some embodiments, after the activeness of the target user in the target application program is enhanced, some target users whose user types are an approximately silent user in the target application program are converted into normal active users. For example, by pushing the activities to the target users for retention, the churn of the target users in the target application program can be effectively prevented, and the purpose of increasing the number of the target users in the target application program is achieved. In another example, after the developer pushes the activities capable of promoting the target application program to the application platform, some users who has not logged into the target application program log in the target application program after seeing the activities on the application platform in the attraction of the activities on the application platform, and the number of the target users in the target application program can also increase.

According to certain embodiments, to better retain the target user by the activities pushed to the application platform, the activities pushed to the application platform are evaluated, and whether the activities are to be continued is determined based on an evaluation result. For example, the evaluation of the activities pushed to the application platform includes: firstly, acquiring the user data of the target user before and after pushing the activities; secondly, evaluating an effect based on the user data of the target user before and after pushing the activities; and thirdly, determining whether an expectation target is reached based on the evaluation result. If the expectation target is reached, the activities are continued. Otherwise, the activities are stopped. To display the effects of the activities pushed to the target user for prevention of user churn, comparison data of two games before and after activities in Table 2 are taken as examples for illustration.

TABLE 2

| | | | Retention | Retention | Retention |
|---|---|---|---|---|---|
| Game | | Return | rate on the | rate within | rate within |
| name | Activities | rate | next day | 3 days | 7 days |
| Game I | Before | 3.47% | 28% | 20% | 18% |
| | activities | | | | |
| | After | 3.34% | 38% | 28% | 25% |
| | activities | | | | |
| | Increased rate | | 35.71% | 40.00% | 38.89% |
| Game II | Before | 2.64% | 30% | 25% | 20% |
| | activities | | | | |
| | After | 2.58% | 35% | 28% | 23% |
| | activities | | | | |
| | Increased rate | | 16.67% | 12.00% | 15.00% |

The return rate corresponds to a rate of return users in churn users to the churn users, according to some embodiments. For example, the retention rate corresponds to a rate of retention users in new users to the new users. As an example, the return rate and the retention rate display the churn situation of the users: the higher the return rate is, the fewer the churn users are; the higher the retention rate is, the fewer the churn users are. As shown in Table 2, the return rates in Game I and Game II before and after the activities are approximately equal, which shows that the numbers of the return users in the two games before and after the activities are almost the same, according to some embodiments. For example, the return rates in Game I and Game II after the activities are apparently higher than those before the activities, which shows decreased churn rate of the target user after the activities, so that pushing the activities to the target user has a positive effect in preventing user churn.

According to certain embodiments, the method 200 is implemented to collect the user data of the target user in the target application program, determine the user type of the target user as the approximately silent user based on the user data of the target user, and push the related data for promoting activeness to the approximately silent user in time, so that retention measures are taken for the approximately silent user in time to effectively prevent the user churn.

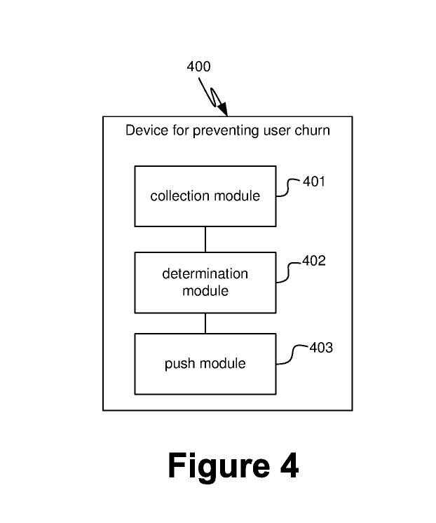

FIG. 4 is a simplified diagram showing a device for preventing user churn according to one embodiment of the present invention. The diagram is merely an example, which should not unduly limit the scope of the claims. One of ordinary skill in the art would recognize many variations, alternatives, and modifications.

According to one embodiment, the device 400 includes: a collection module 401 configured to collect target user data corresponding to one or more target users associated with a target application program, the target user data including user basic attribute information, user behavioral indicator information and user active indicator information; a determination module 402 configured to determine a target user type of the one or more target users based on at least information associated with the target user data of the one or more target users, the target user type including a normal active user, an approximately silent user and a silent user; and a push module 403 configured to, in response to the target user type of the one or more target users being an approximately silent user, push first data for promoting activeness to the one or more target users associated with the target application program.

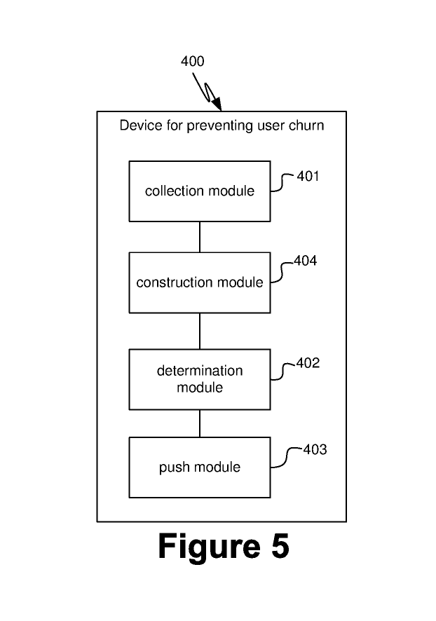

FIG. 5 is a simplified diagram showing a device for preventing user churn according to another embodiment of the present invention. The diagram is merely an example, which should not unduly limit the scope of the claims. One of ordinary skill in the art would recognize many variations, alternatives, and modifications.

According to one embodiment, the device 400 further includes: a construction module 404 configured to pre-construct type models corresponding to different user data. For example, the determination module 402 is further configured to determine the target user type of the one or more target users based on at least information associated with the target user data of the one or more target users and the pre-constructed type models.

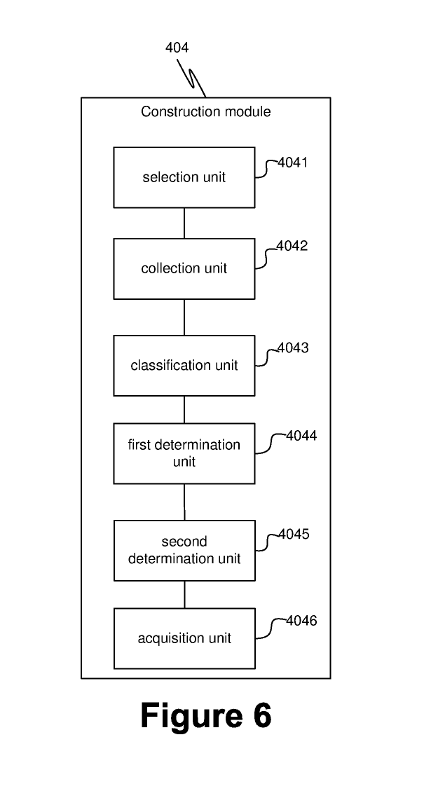

FIG. 6 is a simplified diagram showing a construction module as part of the device as shown in FIG. 4 and/or FIG. 5 according to one embodiment of the present invention. The diagram is merely an example, which should not unduly limit the scope of the claims. One of ordinary skill in the art would recognize many variations, alternatives, and modifications.

According to one embodiment, the construction module 404 includes: a selection unit 4041 configured to select a preset number of users associated with the target application program as modeling users; a collection unit 4042 configured to collect first modeling user data of the preset number of modeling users; a classification unit 4043 configured to classify the preset number of modeling users based on at least information associated with the first modeling user data of the modeling users; a first determination unit 4044 configured to determine churn probabilities associated with the modeling users; a second determination unit 4045 configured to determine modeling user types associated with the modeling users based on at least information associated with the churn probabilities; and an acquisition unit 4046 configured to acquire one or more corresponding type models based on at least information associated with the first modeling user data of the modeling users corresponding to the modeling user types.

According to another embodiment, the collection unit 4042 is further configured to collect second modeling user data of the preset number of modeling users associated with an investigation period and third modeling data of the preset number of modeling users associated with a prediction period, the investigation period and the prediction period being different. For example, the first determination unit 4044 is further configured to determine the churn probabilities associated with the modeling users based on at least information associated with the second modeling user data and the third modeling user data.

Referring back to FIG. 4 and/or FIG. 5, the determination module 402 is configured to match the target user data of the one or more target users with the first modeling user data of the modeling users corresponding to the pre-constructed type models to obtain matched user data of the modeling users and determine the target user type based on at least information associated with the matched user data of the modeling users, according to some embodiments. For example, the device 400 collects the user data of the target user in the target application program and determines the user type of the target user as the approximately silent user based on the user data of the target user. As an example, the device 400 pushes the related data for promoting activeness to the approximately silent user in time and takes retention measures for the approximately silent user in time so as to effectively prevent user churn.

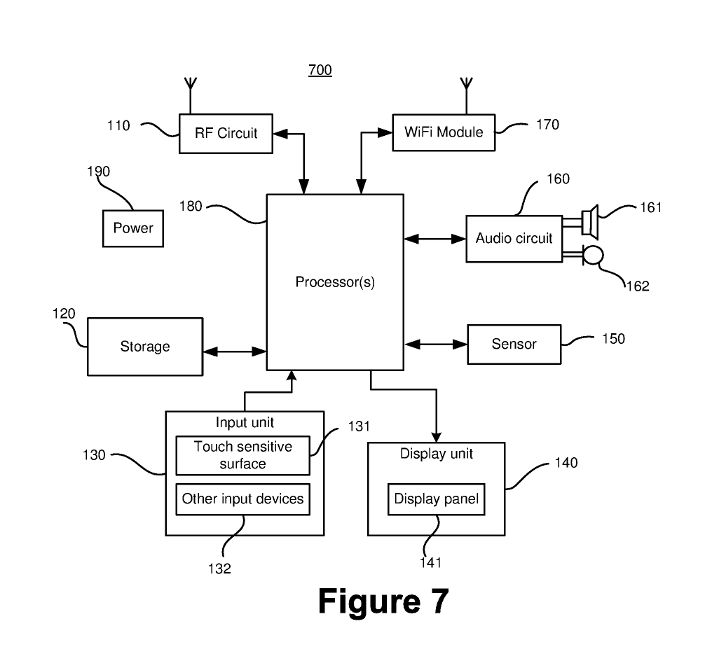

FIG. 7 is a simplified diagram showing a terminal for preventing user churn according to one embodiment of the present invention. The diagram is merely an example, which should not unduly limit the scope of the claims. One of ordinary skill in the art would recognize many variations, alternatives, and modifications.

According to one embodiment, the terminal 700 (e.g., a mobile phone) includes a RF (i.e., radio frequency) circuit 110, a memory 120 (e.g., including one or more computer-readable storage media), an input unit 130, a display unit 140, a sensor 150, an audio circuit 160, a wireless communication module 170, one or more processors 180 that includes one or more processing cores, and a power supply 190. For example, the RF circuit 110 is configured to send/receive messages or signals in communication. As an example, the RF circuit 110 receives a base station's downlink information, delivers to the processors 180 for processing, and sends uplink data to the base station. For example, the RF circuit 110 includes an antenna, at least one amplifier, a tuner, one or several oscillators, SIM (Subscriber Identity Module) card, a transceiver, a coupler, an LNA (Low Noise Amplifier) and/or a duplexer. In another example, the RF circuit 110 communicates with the network and other equipments via wireless communication based on any communication standard or protocols, such as GSM (Global System of Mobile communication), GPRS (General Packet Radio Service), CDMA (Code Division Multiple Access), WCDMA (Wideband Code Division Multiple Access), LTE (Long Term Evolution), email, SMS (Short Messaging Service), etc.

According to another embodiment, the memory 120 is configured to store software programs and modules. For example, the processors 180 are configured to execute various functional applications and data processing by running the software programs and modules stored in the memory 120. The memory 120 includes a program storage area and a data storage area, where the program storage area may store the operating system, and the application(s) required by one or more functions (e.g., an audio player or a video player), in some embodiments. For example, the data storage area stores the data created based on the use of the terminal 700 (e.g., audio data or a phone book). In another example, the memory 120 includes a high-speed random access storage, a non-volatile memory, one or more floppy disc storage devices, a flash storage device or other volatile solid storage devices. As an example, the memory 120 further includes a memory controller to enable access to the memory 120 by the processors 180 and the input unit 130.

According to yet another embodiment, the input unit 130 is configured to receive an input number or character data and generate inputs for a keyboard, a mouse, and a joystick, optical or track signals relating to user setting and functional control. For example, the input unit 130 includes a touch-sensitive surface 131 and other input devices 132. The touch-sensitive surface 131 (e.g., a touch screen or a touch panel) is configured to receive the user's touch operations thereon or nearby (e.g., the user's operations on or near the touch-sensitive surface with a finger, a touch pen or any other appropriate object or attachment) and drive the corresponding connected devices according to the predetermined program. For example, the touch-sensitive surface 131 includes two parts, namely a touch detector and a touch controller. The touch detector detects the position of user touch and the signals arising from such touches and sends the signals to the touch controller. The touch controller receives touch data from the touch detector, converts the touch data into the coordinates of the touch point, sends the coordinates to the processors 180 and receives and executes the commands received from the processors 180. For example, the touch-sensitive surface 131 is of a resistance type, a capacitance type, an infrared type and a surface acoustic wave type. In another example, other than the touch-sensitive surface, the input unit 130 includes the other input devices 132. For example, the other input devices 132 include one or more physical keyboards, one or more functional keys (e.g., volume control keys or switch keys), a track ball, a mouse and/or a joystick.

According to yet another embodiment, the display unit 140 is configured to display data input from a user or provided to the user, and includes various graphical user interfaces of the terminal 700. For example, these graphical user interfaces include menus, graphs, texts, icons, videos and a combination thereof. The display unit 140 includes a display panel 141 which contains a LCD (liquid crystal display), an OLED (organic light-emitting diode). As an example, the touch-sensitive surface can cover the display panel 141. For example, upon detecting any touch operations thereon or nearby, the touch-sensitive surface sends signals to the processors 180 to determine the type of the touch events and then the processors 180 provides corresponding visual outputs on the display panel 141 according to the type of the touch events. Although the touch-sensitive surface 131 and the display panel 141 are two independent parts for input and output respectively, the touch-sensitive surface 131 and the display panel 141 can be integrated for input and output, in some embodiments.

In one embodiment, the terminal 700 includes a sensor 150 (e.g., an optical sensor, a motion sensor). For example, the sensor 150 includes an environment optical sensor and adjusts the brightness of the display panel 141 according to the environmental luminance. In another example, the sensor 150 includes a proximity sensor and turns off or backlights the display panel when the terminal 700 moves close to an ear of a user. In yet another example, the sensor 150 includes a motion sensor (e.g., a gravity acceleration sensor) and detects a magnitude of acceleration in all directions (e.g., three axes). Particularly, the sensor 150 detects a magnitude and a direction of gravity when staying still. In some embodiments, the sensor 150 is used for identifying movements of a cell phone (e.g., a switch of screen direction between horizontal and vertical, related games, and a calibration related to a magnetometer) and features related to vibration identification (e.g., a pedometer or a strike). In certain embodiments, the sensor 150 includes a gyroscope, a barometer, a hygroscope, a thermometer and/or an infrared sensor.

In another embodiment, the audio circuit 160, a speaker 161, and a microphone 162 are configured to provide an audio interface between a user and the terminal 700. For example, the audio circuit 160 is configured to transmit electrical signals converted from certain audio data to the speaker that converts such electrical signals into some output audio signals. In another example, the microphone 162 is configured to convert audio signals into electrical signals which are converted into audio data by the audio circuit 160. The audio data are processed in the processors 180 and received by the RF circuit 110 before being sent to another terminal, in some embodiments. For example, the audio data are output to the memory 120 for further processing. As an example, the audio circuit 160 includes an earphone jack for communication between a peripheral earphone and the terminal 700.

According to some embodiments, the wireless communication module 170 includes a WiFi (e.g., wireless fidelity, a short-distance wireless transmission technology) module, a Bluetooth module, an infrared communication module, etc. In some embodiments, through the wireless communication module 170, the terminal 700 enables the user to receive and send emails, browse webpages, and/or access stream media. For example, the terminal 700 is configured to provide the user with a wireless broadband Internet access. In some embodiments, the wireless communication module 170 is omitted in the terminal 700.

According to one embodiment, the processors 180 are the control center of the terminal 700. For example, the processors 180 is connected to various parts of the terminal 700 (e.g., a cell phone) via various interfaces and circuits, and executes various features of the terminal 700 and processes various data through operating or executing the software programs and/or modules stored in the memory 120 and calling the data stored in the memory 120, so as to monitor and control the terminal 700 (e.g., a cell phone). As an example, the processors 180 include one or more processing cores. In another example, the processors 180 is integrated with an application processor and a modem processor, where the application processor mainly handles the operating system, the user interface and the applications and the modem processor mainly handles wireless communications. In some embodiments, the modem processor is not integrated into the processors 180.

According to another embodiment, the terminal 700 includes the power supply 190 (e.g., a battery) that powers up various parts. For example, the power supply 190 is logically connected to the processors 180 via a power source management system so that the charging, discharging and power consumption can be managed via the power source management system. In another example, the power supply 190 includes one or more DC or AC power sources, a recharging system, a power-failure-detection circuit, a power converter, an inverter, a power source state indicator, or other components. In yet another example, the terminal 700 includes a camcorder, a Bluetooth module, a near field communication module, etc.

According to some embodiments, the processors 180 of the terminal 700 load executable files/codes associated with one or more applications to the memory 120 and run the applications stored in the memory 120 according to the method 100 as shown in FIG. 1 and/or the method 200 as shown in FIG. 2. According to certain embodiments, a computer readable storage medium is configured to store executable files/codes associated with one or more applications which can be executed using one or more data processors to perform the method 100 as shown in FIG. 1 and/or the method 200 as shown in FIG. 2. For example, the storage medium is included in the memory 120. In another example, the storage medium is not included in the terminal 700. According to some embodiments, a graphic user interface is implemented on a terminal (e.g., the terminal 700) for preventing user churn. For example, the graphic user interface is used for performing the method 100 as shown in FIG. 1 and/or the method 200 as shown in FIG. 2.

According to one embodiment, a method is provided for preventing user churn. For example, target user data corresponding to one or more target users associated with a target application program is collected, the target user data including user basic attribute information, user behavioral indicator information and user active indicator information; a target user type of the one or more target users is determined based on at least information associated with the target user data of the one or more target users, the target user type including a normal active user, an approximately silent user and a silent user; and in response to the target user type of the one or more target users being an approximately silent user, first data for promoting activeness is pushed to the one or more target users associated with the target application program. For example, the method is implemented according to at least FIG. 1 and/or FIG. 2.

According to another embodiment, a device for preventing user churn includes: a collection module configured to collect target user data corresponding to one or more target users associated with a target application program, the target user data including user basic attribute information, user behavioral indicator information and user active indicator information; a determination module configured to determine a target user type of the one or more target users based on at least information associated with the target user data of the one or more target users, the target user type including a normal active user, an approximately silent user and a silent user; and a push module configured to, in response to the target user type of the one or more target users being an approximately silent user, push first data for promoting activeness to the one or more target users associated with the target application program. For example, the device is implemented according to at least FIG. 4 and/or FIG. 5.

According to yet another embodiment, a non-transitory computer readable storage medium includes programming instructions for preventing user churn. For example, target user data corresponding to one or more target users associated with a target application program is collected, the target user data including user basic attribute information, user behavioral indicator information and user active indicator information; a target user type of the one or more target users is determined based on at least information associated with the target user data of the one or more target users, the target user type including a normal active user, an approximately silent user and a silent user; and in response to the target user type of the one or more target users being an approximately silent user, first data for promoting activeness is pushed to the one or more target users associated with the target application program. For example, the storage medium is implemented according to at least FIG. 1 and/or FIG. 2.

The above only describes several scenarios presented by this invention, and the description is relatively specific and detailed, yet it cannot therefore be understood as limiting the scope of this invention. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

1. A processor-implemented method for preventing user churn, the method comprising:
collecting, using one or more data processors, target user data corresponding to one or more target users associated with a target application program, the target user data including user basic attribute information, user behavioral indicator information and user active indicator information;
determining, using the data processors, a target user type of the one or more target users based on at least information associated with the target user data of the one or more target users, the target user type including a normal active user, an approximately silent user and a silent user; and
in response to the target user type of the one or more target users being an approximately silent user, pushing, using the data processors, first data for promoting activeness to the one or more target users associated with the target application program.

2. The method of claim 1, further comprising:
pre-constructing type models corresponding to different user data;
the determining a target user type of the one or more target users based on at least information associated with the target user data of the one or more target users includes: determining the target user type of the one or more target users based on at least information associated with the target user data of the one or more target users and the pre-constructed type models.

3. The method of claim 2, wherein the pre-constructing type models corresponding to different user data includes:
selecting a preset number of users associated with the target application program as modeling users;
collecting first modeling user data of the preset number of modeling users;
classifying the preset number of modeling users based on at least information associated with the first modeling user data of the modeling users;
determining churn probabilities associated with the modeling users;
determining modeling user types associated with the modeling users based on at least information associated with the churn probabilities; and
acquiring one or more corresponding type models based on at least information associated with the first modeling user data of the modeling users corresponding to the modeling user types.

4. The method of claim 3, wherein the collecting first modeling user data of the preset number of modeling users includes:
collecting second modeling user data of the preset number of modeling users associated with an investigation period and third modeling data of the preset number of modeling users associated with a prediction period, the investigation period and the prediction period being different;
the determining churn probabilities associated with the modeling users includes: determining the churn probabilities associated with the modeling users based on at least information associated with the second modeling user data and the third modeling user data.

5. The method of claim 3, wherein the determining the target user type of the one or more target users based on at least information associated with the target user data of the one or more target users and the pre-constructed type models includes:
matching the target user data of the one or more target users with the first modeling user data of the modeling users corresponding to the pre-constructed type models to obtain matched user data of the modeling users; and
determining the target user type based on at least information associated with the matched user data of the modeling users.

6. A device for preventing user churn, the device comprising:
a collection module configured to collect target user data corresponding to one or more target users associated with a target application program, the target user data including user basic attribute information, user behavioral indicator information and user active indicator information;
a determination module configured to determine a target user type of the one or more target users based on at least information associated with the target user data of the one or more target users, the target user type including a normal active user, an approximately silent user and a silent user; and
a push module configured to, in response to the target user type of the one or more target users being an approximately silent user, push first data for promoting activeness to the one or more target users associated with the target application program.

7. The device of claim 6, further comprising:
a construction module configured to pre-construct type models corresponding to different user data;
wherein the determination module is further configured to determine the target user type of the one or more target users based on at least information associated with the target user data of the one or more target users and the pre-constructed type models.

8. The device of claim 7, wherein the construction module includes:
a selection unit configured to select a preset number of users associated with the target application program as modeling users;
a collection unit configured to collect first modeling user data of the preset number of modeling users;
a classification unit configured to classify the preset number of modeling users based on at least information associated with the first modeling user data of the modeling users;
a first determination unit configured to determine churn probabilities associated with the modeling users;
a second determination unit configured to determine modeling user types associated with the modeling users based on at least information associated with the churn probabilities; and
an acquisition unit configured to acquire one or more corresponding type models based on at least information associated with the first modeling user data of the modeling users corresponding to the modeling user types.

9. The device of claim 8, wherein:
the collection unit is further configured to collect second modeling user data of the preset number of modeling users associated with an investigation period and third modeling data of the preset number of modeling users associated with a prediction period, the investigation period and the prediction period being different;
the first determination unit is further configured to determine the churn probabilities associated with the modeling users based on at least information associated with the second modeling user data and the third modeling user data.

10. The device of claim 8, wherein:
the determination module is configured to match the target user data of the one or more target users with the first modeling user data of the modeling users corresponding to the pre-constructed type models to obtain matched user data of the modeling users and determine the target user type based on at least information associated with the matched user data of the modeling users.

11. The device of claim 6, further comprising:
one or more data processors; and
a computer-readable storage medium;
wherein one or more of the collection module, the determination module, and the push module are stored in the storage medium and configured to be executed by the one or more data processors.

12. A non-transitory computer readable storage medium comprising programming instructions for preventing user churn, the programming instructions configured to cause one or more data processors to execute operations comprising:
collecting target user data corresponding to one or more target users associated with a target application program, the target user data including user basic attribute information, user behavioral indicator information and user active indicator information;
determining a target user type of the one or more target users based on at least information associated with the target user data of the one or more target users, the target user type including a normal active user, an approximately silent user and a silent user; and
in response to the target user type of the one or more target users being an approximately silent user, pushing first data for promoting activeness to the one or more target users associated with the target application program.

13. The method of claim 4, wherein the determining the target user type of the one or more target users based on at least information associated with the target user data of the one or more target users and the pre-constructed type models includes:
matching the target user data of the one or more target users with the first modeling user data of the modeling users corresponding to the pre-constructed type models to obtain matched user data of the modeling users; and
determining the target user type based on at least information associated with the matched user data of the modeling users.

14. The device of claim 9, wherein:
the determination module is configured to match the target user data of the one or more target users with the first modeling user data of the modeling users corresponding to the pre-constructed type models to obtain matched user data of the modeling users and determine the target user type based on at least information associated with the matched user data of the modeling users.
